(19) United States
(12) Patent Application Publication
(10) Pub. No.: US 2015/0172093 A1
(43) Pub. Date: Jun. 18, 2015

(54) MANAGEMENT APPARATUS, MANAGEMENT METHOD, AND MANAGEMENT PROGRAM

(71) Applicant: HITACHI, LTD., Tokyo (JP)

(72) Inventors: Kosuke KANEKO, Tokyo (JP); Jyunji KINOSHITA, Tokyo (JP); Yuichi TAGUCHI, Tokyo (JP); Osamu TAKADA, Tokyo (JP)

(21) Appl. No.: 14/570,052

(22) Filed: Dec. 15, 2014

(30) Foreign Application Priority Data
Dec. 16, 2013 (JP) 2013-259092

(51) Int. Cl. H04L 12/24

(52) U.S. Cl. CPC H04L 41/0226; H04L 41/022; H04L 41/024; H04L 41/0806

(57) ABSTRACT

In an MB management system, a user who wishes to use a network service sends MB requirements from a user terminal to a network management apparatus, which is managed by a provider who provides a network service. The network management apparatus returns to the user terminal abstract models as a guide for the performance and the like of MBs that are available in the network service and that meet the MB requirements. The user operates the user terminal to select an MB that the user is to use from among the provided abstract models. The user also receives via the user terminal from the network management apparatus the operational status of an instance of the MB selected from among the abstract models. This allows the user to compare the MB requirements presented by the user and the actual operational status of the MB instance.

### CLAIM OF PRIORITY

The present application claims priority from Japanese patent application JP 2013-259092 filed on Dec. 16, 2013, the content of which is hereby incorporated by reference into this application.

### BACKGROUND

This invention relates to a management apparatus, management method, and management program for managing a network apparatus.

The use of data centers as the foundation of a cloud service or the like is advancing in recent years. In data centers, middleboxes (hereinafter a middlebox is abbreviated as MB) such as a firewall, which handles communication security, and a load balancer, which handles load balancing to fully utilize a communication band, are elements indispensable to carry out services. MBs are defined in, for example, RFC 3234. MBs are provided by various vendors, and vary in function from model to model. There are also various modes of MBs such as virtual MBs, which are implemented as virtual apparatus, and physical MBs, which are implemented as physical dedicated apparatus.

Despite this situation where such diverse MB models are all on the market, there are no performance standards, reliability standards, and function standards for MBs. In addition, the need to take various conditions into account makes defining those standards difficult. For instance, the performance of an MB varies depending on the amount of computer resources allocated, and also on whether parallel processing through multiplexing is executed. The reliability of an MB can be enhanced by utilizing a redundancy providing function that is included in the MB or by utilizing a redundancy providing function that is included in a virtual apparatus management mechanism.

MBs provided by different vendors may have the same function that are named differently, or may have functions that are named the same but are actually different functions. Further, individual MBs have their own characteristics such as having high performance only in a particular function, or having poor compatibility with a particular model. Those characteristics are know-how and are not likely to be known outside of the MBs' vendors.

It is thus difficult for providers and users of MBs to define the MBs' performance, reliability, and function (hereinafter referred to as “performance and the like”). For providers of MBs, for example, a business who rents MBs as a part of a network service, the difficulty in defining the performance and the like of MBs makes it difficult to present service specifications to users. The difficulty also makes it difficult to select an MB suitable for a user when the user presents requirements.

For users of MBs, for example, a user who uses a network service and rents an MB, service specifications are not presented and selecting an MB that meets his/her requirements is accordingly difficult. Even when the user manages to select an MB that seems suitable, determining the adequacy of the selected MB for the requirements would not be easy.

Related Art 1 attempts to solve those problems by setting a default MB model as MBs to be automatically allocated to users and thus saving users the trouble of selecting a middlebox (see, for example, an online article titled “CloudStack Administrator's Guide”, written by Jessica Tomechak on May 29, 2012, published by Apache Software Foundation, and retrieved October 2013 from an Internet site located at http://cloudstack.apache.org/docs/en-US/Apache_CloudStack/4.1.1/html/Admin_Guide/network-service-providers.html). With Related Art 1, a provider can provide MBs of its affiliated vendors to users as options in addition to MBs of the default model. Examples of the related art that defines the performance and the like of an MB from the result of operating the MB include Related Art 2 in which, based on data accumulated through the monitoring of Wide Area Network (WAN) optimizers, the WAN optimizers are automatically adjusted in size and the load balancing settings of the WAN optimizers are selected automatically (WO 2013/055812 A, Abstract, p. 1 to p. 4, p. 94 to p. 104, FIGS. 6B, 6C, and 6D).

### SUMMARY

However, Related Art 1 does not solve the problem of providers' difficulty in presenting service specifications. In addition, presenting options of MBs from affiliated vendors does not change users' difficulty in selecting a suitable MB, nor the difficulty in determining adequacy after the selection.

In Related Art 2, there is no mention of what criteria are used when automatically selecting the size and settings of an MB, and requirements of a user cannot be taken into account in the selection. Related Art 2 also mentions only WAN optimizers, which are a type of MBs, and cannot be applied to other types of MBs.

The disclosure enables to facilitate the selection of a network apparatus that implements a function type selected from among a plurality of function types.

An aspect of the disclosure in this application is a management apparatus for managing a group of network apparatus each being configured to implement a type selected from a plurality of types, the management apparatus being configured to: manage, for each network apparatus in the group, information comprising at least one of a function identified by the selected type, an actual value of performance that is exerted when the function is enabled, or an actual value of reliability that is exerted when the function is enabled; obtain at least one requirement out of a function requirement, a performance requirement, and a reliability requirement that are required of the type selected from the plurality of types; and select from the group a network apparatus that fulfills the requirement obtained, by referring to the information that is stored.

According to the exemplary embodiment of the disclosure, the selection of a network apparatus that implements a function type selected from among a plurality of function types can be facilitated. Other objects, configurations, and effects than those described above are clarified by the following description of an embodiment.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an explanatory diagram outlining an MB management system according to this embodiment.

FIG. 2 is an explanatory diagram illustrating a system configuration example of the MB management system according to this embodiment.

FIG. 3 is a block diagram illustrating a hardware configuration example of the network management apparatus.

FIG. 4 is an explanatory diagram illustrating an example of what is stored in the MB abstract model table.

FIG. 5 is an explanatory diagram illustrating an example of what is stored in the MB model table.

FIG. 6 is an explanatory diagram illustrating an example of what is stored in a first know-how table, which is one of tables included in the MB know-how table.

FIG. 7 is an explanatory diagram illustrating an example of what is stored in a second know-how table, which is one of tables included in the MB know-how table.

FIG. 8 is an explanatory diagram illustrating an example of what is stored in the MB instance Table.

FIG. 9 is an explanatory diagram illustrating an example of what is stored in the MB instance operational status table.

FIG. 10 is a block diagram illustrating a hardware configuration example of each of the server 6 and the VM management apparatus.

FIG. 11 is a block diagram illustrating a hardware configuration example of each MB.

FIG. 12 is a sequence diagram illustrating an example of an overall sequence in the MB management system.

FIG. 13 is a flow chart illustrating an example of processing steps of updating the second know-how table, which is illustrated in FIG. 7.

FIG. 14 is a flow chart illustrating an example of processing steps of updating the MB abstract model table.

FIG. 15 is a flow chart illustrating an example of processing steps of updating the MB instance operational status table.

FIG. 16 is a flow chart illustrating an example of steps of the MB selecting processing, which is illustrated in FIG. 12.

### DETAILED DESCRIPTION OF THE EMBODIMENT

In the following embodiment, programs may be mentioned as agents for the convenience of description, but those programs are actually executed by an arithmetic unit such as a processor. Components to be managed in the following embodiments are network apparatus each being configured to implement a type of function (hereinafter shortened as type) selected from among a plurality of function types such as firewall, load balancer, and router. The description takes MBs as an example of the network apparatus to be managed.

<Outline of an MB Management System>

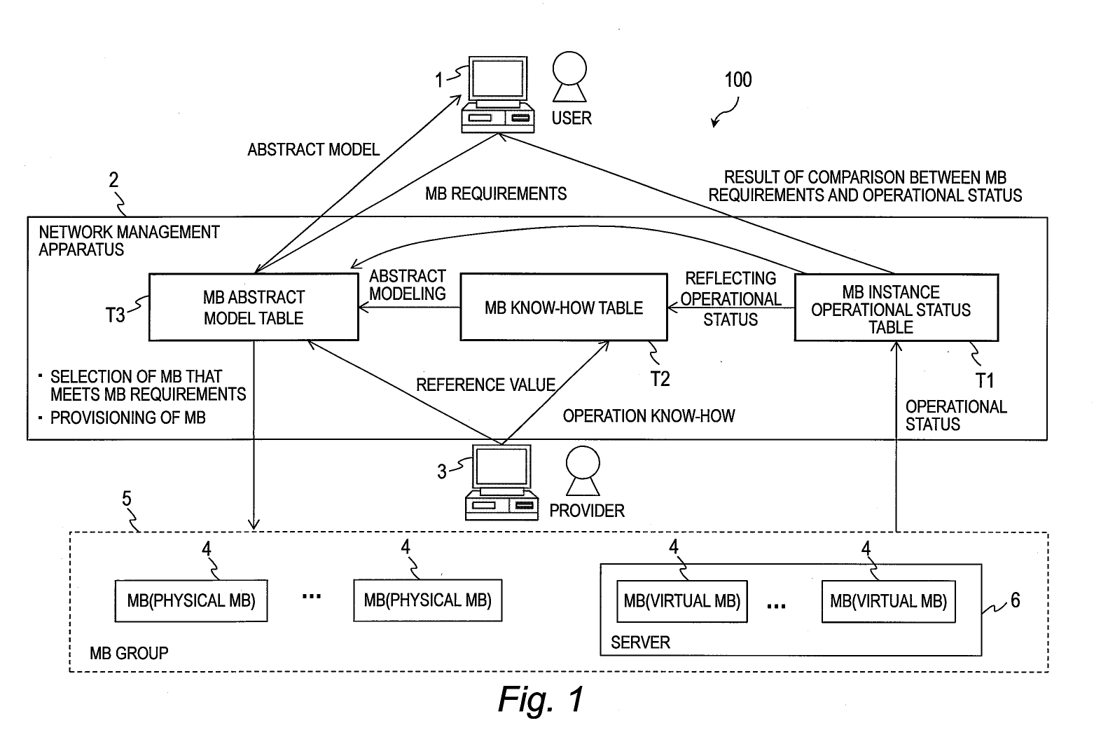

FIG. 1 is an explanatory diagram outlining an MB management system 100 according to this embodiment. In this embodiment, a user who wishes to use a network service sends requirements required of an MB (MB requirements) from a user terminal 1 to a network management apparatus 2, which is managed by a provider who provides a network service. The network management apparatus 2 returns to the user terminal 1 abstract models as a guide for the performance and the like of MBs that are available in the network service and that meet the MB requirements. The user operates the user terminal 1 to select an MB that the user is going to use from among the provided abstract models. Selecting an MB is thus made easier for the user.

The user also receives via the user terminal 1 from the network management apparatus 2 the operational status of an instance of the MB (MB instance) selected from among the abstract models. An MB instance (or simply “instance”) is an MB that has been set up for a user's use. This allows the user to compare the MB requirements presented by the user and the actual operational status of the MB instance, thereby checking whether the operational status fulfills the MB requirements.

The network management apparatus 2 includes an MB instance operational status table T1 and an MB know-how table T2. The MB instance operational status table T1 is a table in which the operational status of MB instances is collected. The network management apparatus 2 collects the operational status of MB instances from an MB group 5. The MB group 5 includes at least one of physical MBs and virtual MBs. Virtual MBs are executed on a server 6. Herein, physical MBs and virtual MBs are indiscriminately referred to as MBs unless particularly noted.

The MB know-how table T2 is a table for storing MB industry know-how that the provider possesses and operation know-how based on the operational status of MBs. The MB know-how table T2 is a table generated based on those types of know-how and the MB instance operational status table T1. The MB know-how table T2 accumulates such know-how as a communication failure between MBs. The network management apparatus 2 updates the MB know-how table T2 by collecting the actual operational status of enabled performance and the like from MB instances.

The network management apparatus 2 also generates an MB abstract model table T3 which defines reference for the performance and the like of MBs, based on an input from a provider terminal 3. When receiving MB requirements from the user terminal 1 as described above, the network management apparatus 2 refers to the MB abstract model table T3 to extract MB abstract models that fulfill the MB requirements, and returns the extracted MB abstract models to the user terminal 1. The MB know-how table T2 and the MB abstract model table T3 reflect the operational status of MB instances as needed.

The network management apparatus 2 selects from the MB group 5 a model that fulfills reference values of the MB selected by the user from among the MB abstract models, and performs provisioning on the model. Provisioning is to set up at least one MB from the MB group 5 for use by the user terminal 1. The set up MB is the MB instance described above. Setting up an MB is also expressed as generating an instance.

The network management apparatus 2 compares the operational status of the MB instance and the MB requirements to identify a discrepancy between the two, and provides this discrepancy information to the user terminal 1 and the provider terminal 3.

This embodiment enables the provider to provide MB abstract models as reference for the performance and the like of MBs to a user. Referring to the provided reference makes it easy for the user to select an MB by determining whether the reference matches his/her MB requirements, trying to use a reference model first when the user does not have a clear idea about what his/her MB requirements are, or the like. The user is further notified of discrepancy information about a discrepancy between the operational status of an MB instance that the user is using and the user's MB requirements, which enables the user to determine with ease whether the MB instance is appropriate for his/her MB requirements.

<System Configuration Example>

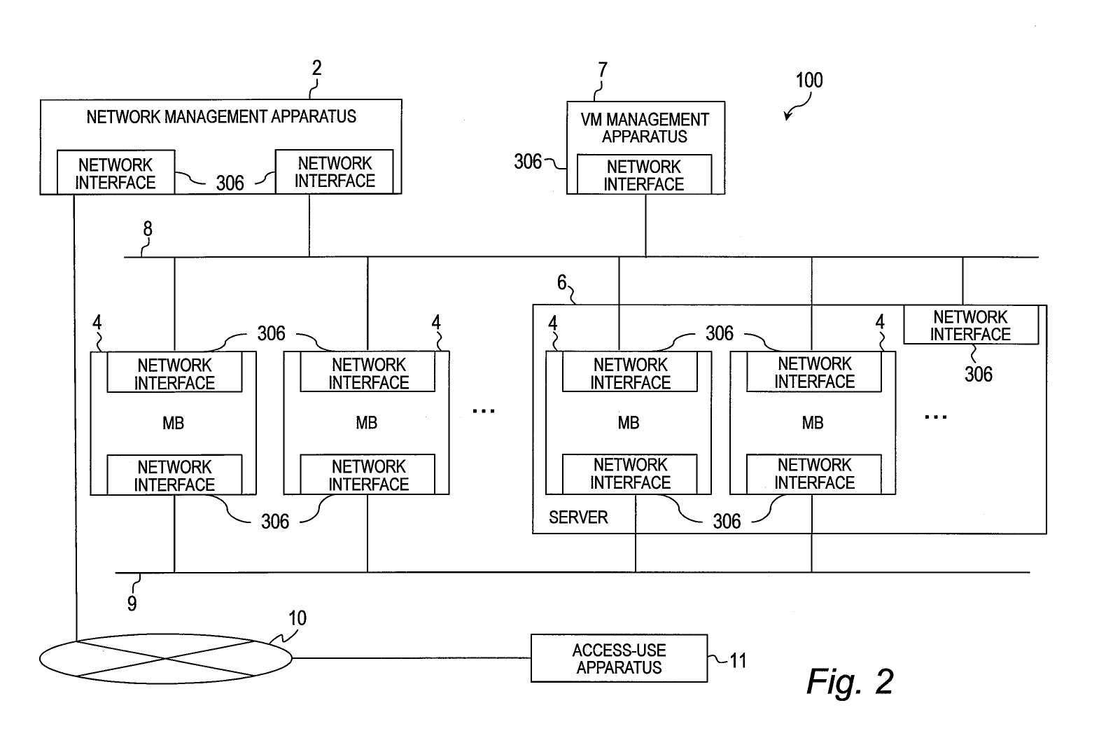

FIG. 2 is an explanatory diagram illustrating a system configuration example of the MB management system 100 according to this embodiment. The MB management system 100 includes the network management apparatus 2, MBs 4, the server 6, and a VM management apparatus 7. The network management apparatus 2, the MBs 4, the server 6, and the VM management apparatus 7 are coupled by their respective network interfaces 306 to a management-use network 8, where communication traffic for controlling cooperation among the apparatus 2 to 7 flows. The server 6 executes the MBs 4 as virtual machines. The VM management apparatus 7 manages the virtual machines.

The MBs 4 are also coupled to a service network 9, where communication traffic of the user flows. The user's communication traffic is, for example, transmission/reception packets of the user's Web server (not shown).

As illustrated in FIG. 1, the user inputs MB requirements for an MB that the user wishes to use from the user terminal 1 to the network management apparatus 2, and the provider inputs know-how of MBs from the provider terminal 3 to the network management apparatus 2. The provider may input MB requirements from the provider terminal 3 and the user may input know-how of the MBs 4 from the user terminal 1. Those inputs are made via an access-use apparatus 11. The access-use apparatus 11 is coupled to the network management apparatus 2 via an access-use network 10.

The access-use network 10 is a network such as the Internet or a WAN. This embodiment is not limited to the configuration of FIG. 2, and the access-use apparatus 11 may be coupled to the management-use network 8, or the access-use apparatus 11 that is handled by the provider may be coupled to the management-use network 8 while the access-use apparatus 11 that is handled by the user is coupled to the access-use network 10.

<Hardware Configuration Example of the Network Management Apparatus 2>

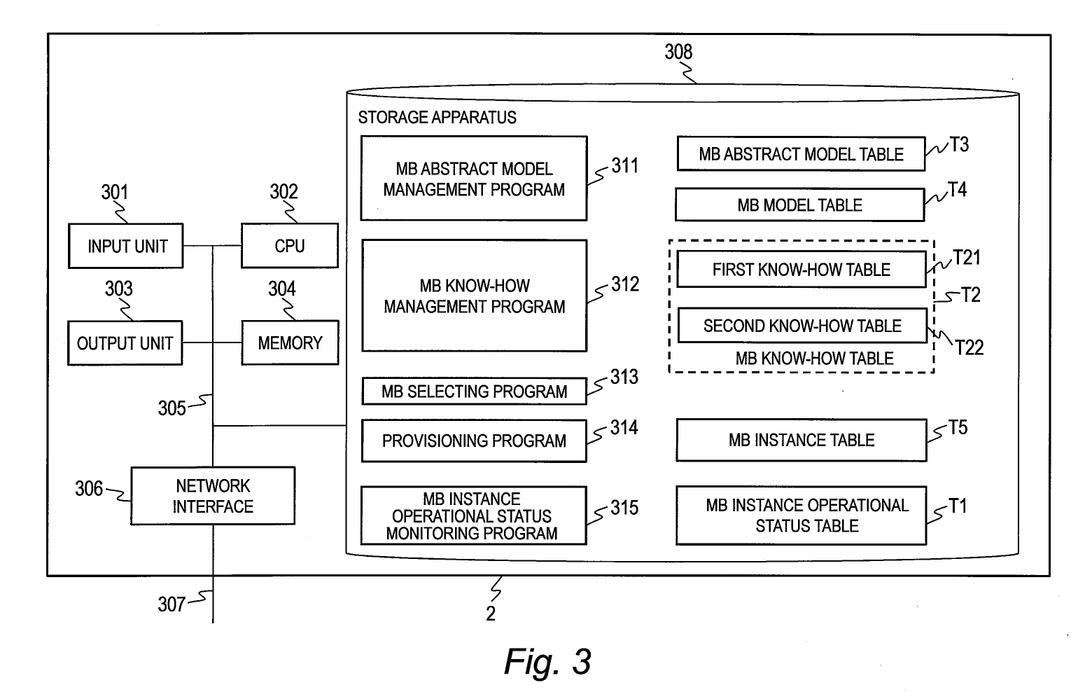

FIG. 3 is a block diagram illustrating a hardware configuration example of the network management apparatus 2. The network management apparatus 2 includes an input unit 301, a central processing unit (CPU) 302, an output unit 303, a memory 304, a network interface 306, a storage apparatus 308, and a data bus 305, which couples those components to one another. Each of the components may be provided in multitudes.

The input unit 301 is an interface that couples to an input apparatus such as a keyboard. The CPU 302 is a processor that executes programs in the storage apparatus 308. The output unit 303 is an interface that outputs execution results of the CPU 302 to a monitor or a similar apparatus. The memory 304 stores halfway results of execution by the CPU 302. The network interface 306 couples to a line 307, which is coupled to the management-use network 8. The storage apparatus 308 stores various programs and various tables. The storage apparatus 308 is a non-transitory storage medium that can be read by the CPU 302.

The various tables stored in the storage apparatus 308 include the MB instance operational status table T1, the MB know-how table T2, the MB abstract model table T3, an MB model table T4, and an MB instance table T5. The tables T1 to T5, which are inside the storage apparatus 308, may instead be outside the network management apparatus 2 as long as the network management apparatus 2 can access the tables T1 to T5.

The various programs stored in the storage apparatus 308 include an MB abstract model management program 311, an MB know-how management program 312, an MB selecting program 313, a provisioning program 314, and an MB instance operational status monitoring program 315. The MB abstract model management program 311 is a program that manages the MB abstract model table T3. The MB know-how management program 312 is a program that manages the MB know-how table T2. The MB selecting program 313 is a program that refers to the MB know-how table T2 and executes the selecting of an MB. The provisioning program 314 is a program that generates an MB instance of an MB selected by the MB selecting program 313, and updates the MB instance table T5. The MB instance operational status monitoring program 315 is a program that obtains, from an MB instance, monitoring information of the MB instance, and updates the MB instance operational status table T1.

<Example of Information Stored in the Tables>

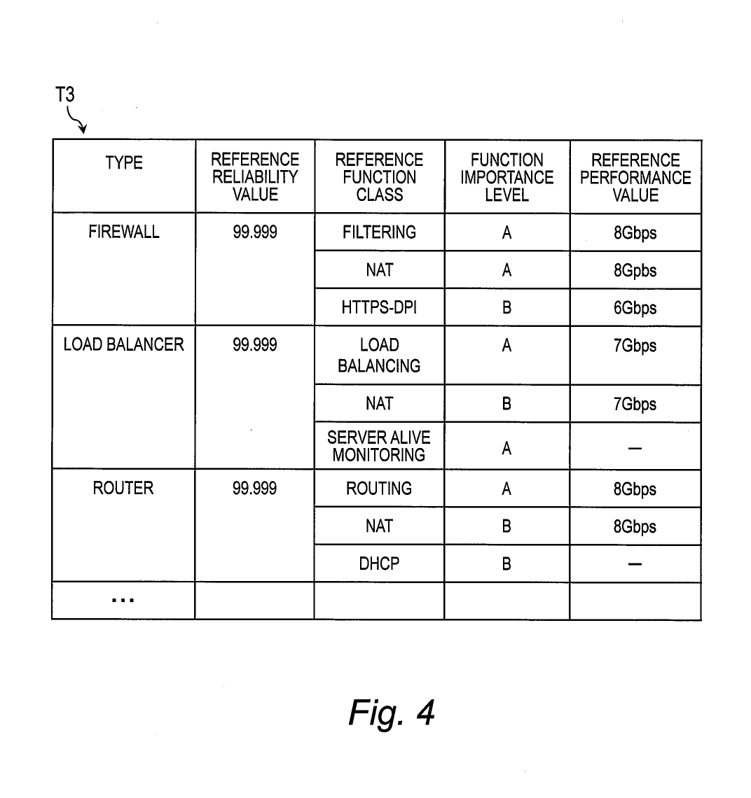

FIG. 4 is an explanatory diagram illustrating an example of what is stored in the MB abstract model table T3. The MB abstract model table T3 is a table that stores, for each type of the MBs 4, reference for the performance and the like which is used to identify MB abstract models of MBs. The MB abstract model table T3 includes a type field, a reference reliability value field, a reference function class field, a function importance level field, and a reference performance value field, and stores values of the respective fields for each MB abstract model. The values of the respective fields are input from, for example, the provider terminal 3.

The type field stores in each entry the type of the MB 4 in question. “Type” here indicates what sort of function the MB 4 has, for example, firewall, load balancer, or router. The reference reliability value field stores in each entry a reference reliability value. The reference reliability value is a reliability value (%) that serves as reference for the MB 4 identified by type. The reliability value is an index value that indicates how reliable the MB 4 identified by type is. The MB 4 that has a higher reference reliability value is less likely to stop running.

The reference function class field stores in each entry a reference function class. The reference function class is a function class that serves as reference. The function class of the MB 4 identified by type is a function class that can be implemented by the MB 4. For example, function classes that can be implemented by a firewall include filtering, Network Address Translation (NAT), and Hypertext Transfer Protocol over SSL/TLS-Deep Packet Inspection (HTTPS-DPI).

The function importance level field stores in each entry a function importance level. The function importance level is the importance level of a function class that is registered as a reference function class. In this example, a function importance level “A” indicates that the reference function class in question is an indispensable element, and a function importance level “B” indicates that the reference function class in question is an optional element. The indispensable element is a function class that is always used to implement the type in question. The optional element is a function class that is used optionally to implement the type in question.

The reference performance value field stores in each entry a reference performance value. The reference performance value is a performance value that serves as reference for a reference function class. Communication speed, for example, is used here as the performance value.

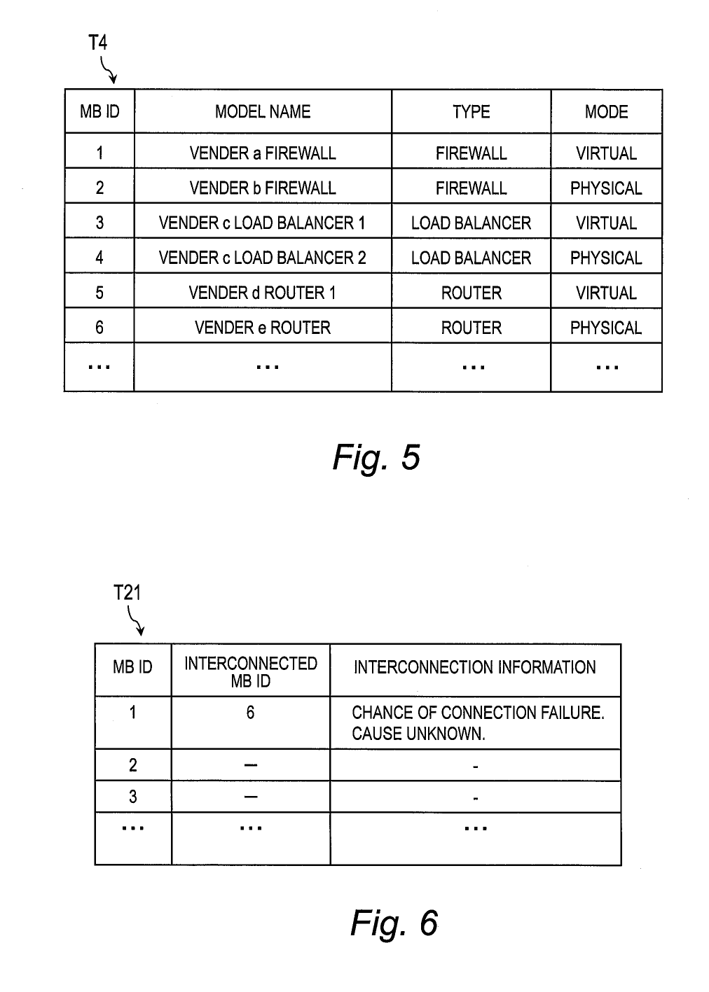

FIG. 5 is an explanatory diagram illustrating an example of what is stored in the MB model table T4. The MB model table T4 is a table that stores information about the models of the MBs 4. The MB model table T4 is necessary because the MBs 4 vary in name and type from one vendor who provides the MBs 4 to another. The MB model table T4 has, for each MB 4, a cell in an MB ID field, a cell in a model name field, a cell in a type field, and a cell in a mode field so that values of the respective fields are held for each MB 4. The values of the respective fields are input by, for example, the provider.

The MB ID field stores in each entry an MB ID. The MB ID of one MB 4 is identification information for uniquely identifying the MB 4. The model name field stores in each entry the model name of the MB 4 that is identified by an MB ID registered in the entry. Different vendors use different model names. For example, the same firewall is called by different model names by different vendors. The type field stores in each entry the type of the MB 4 that is identified by an MB ID registered in the entry. The mode field stores in each entry the mode of the MB 4 that is identified by an MB ID registered in the entry. A mode stored in the mode field indicates the mode of implementing the MB 4 in question, which is a physical mode or a virtual mode.

FIG. 6 is an explanatory diagram illustrating an example of what is stored in a first know-how table T21, which is one of tables included in the MB know-how table T2. The first know-how table T21 is a table that stores know-how of interconnection relations between the MBs 4 as compatibility between the MBs 4. The first know-how table T21 is used to exclude a combination of the MBs 4 that has a poor coupling compatibility from a selection of the MBs 4 to be provided to the user. The first know-how table T21 includes an MB ID field, an interconnected MB ID field, and an interconnection information field, and holds values of the respective fields for each MB 4. The values of the respective fields are input from, for example, the provider terminal 3.

The interconnected MB ID field stores in each entry an interconnected MB ID. The interconnected MB ID is identification information for uniquely identifying an interconnected MB. The interconnected MB registered in an entry is the MB 4 interconnected to the MB 4 that is identified by an MB ID registered in the entry. The interconnection information field stores in each entry interconnection information. The interconnection information registered in an entry is know-how about interconnection between the MB 4 that is identified by an MB ID registered in the entry and the MB 4 that is identified by an interconnected MB ID registered in the entry. Examples of the know-how include actual accounts of the interconnection, and information about whether the coupling compatibility is good or poor. In the case of FIG. 6, know-how such as “CHANCE OF CONNECTION FAILURE. CAUSE UNKNOWN.” is stored in an entry for interconnection between the MB 4 that has an MB ID “1” and the MB 4 that has an interconnected MB ID “6”.

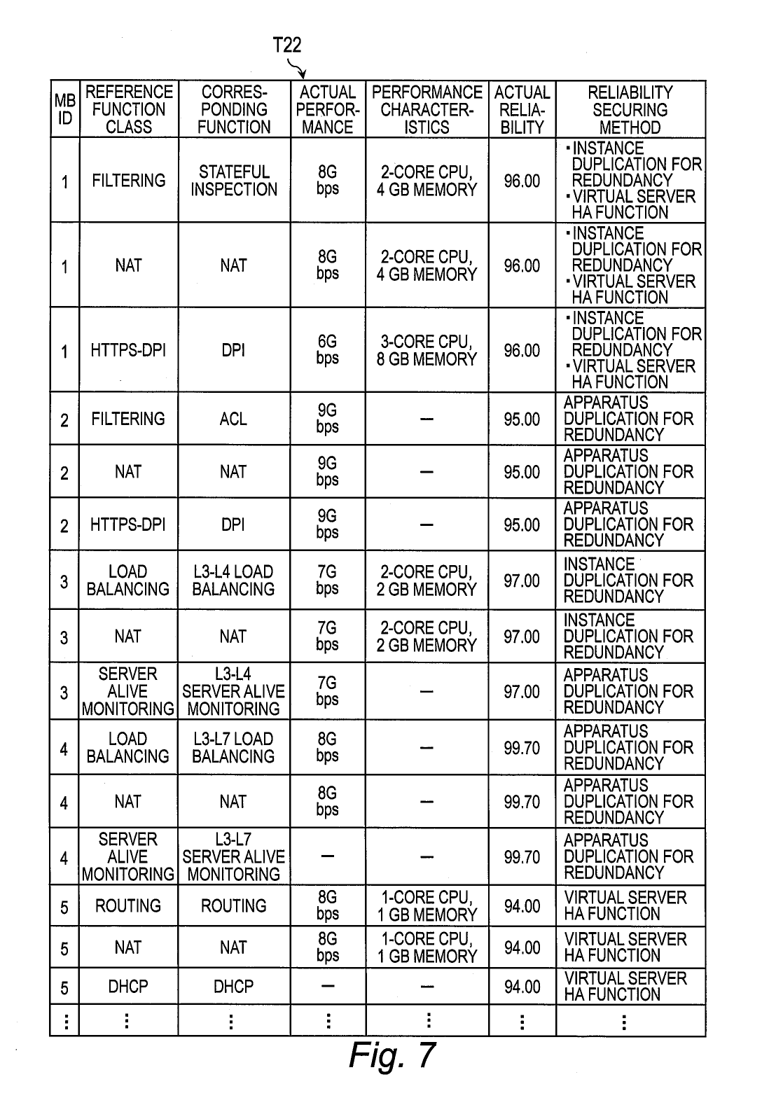

FIG. 7 is an explanatory diagram illustrating an example of what is stored in a second know-how table T22, which is one of tables included in the MB know-how table T2. The second know-how table T22 is a table that stores know-how related to the function, performance, and reliability of MB 4. The second know-how table T22 is used to associate each MB 4 with a corresponding function and with the actual performance and actual reliability of each function, and to integrate different names of the same function into one name. The second know-how table T22 includes an MB ID field, a reference function class field, a corresponding function field, an actual performance field, a performance characteristics field, an actual reliability field, and a reliability securing method field, and holds values of the respective fields for each MB 4. The values of the respective fields are input from, for example, the provider terminal 3.

The corresponding function field stores in each entry the name of a corresponding function. The corresponding function of one MB 4 is a concrete function of the MB 4 that corresponds to a reference function class. For example, a corresponding function of one MB 4 is a function prepared by a vendor that corresponds to a reference function class of the MB 4. The actual performance field stores in each entry actual performance. The actual performance of one MB 4 is the actual value of the performance, for example, communication speed, of the MB 4.

The performance characteristics field stores in each entry performance characteristics. The performance characteristics of one MB 4 are characteristics by which the MB 4 exerts its performance. In this example, a resource amount is stored as an example of performance characteristics when the MB 4 that is identified by an MB ID registered in an entry is a virtual MB. In other words, the MB 4 for which no value is stored in the performance characteristics field is a physical MB.

The actual reliability field stores in each entry actual reliability (%). The actual reliability of one MB 4 is information that indicates actual reliability of the MB 4, for example, the operating rate (the rate at which the MB 4 has not stopped running). The reliability securing method field stores in each entry a reliability securing method. The reliability securing method of one MB 4 is a method of implementing the MB 4 that was employed when registered actual reliability was obtained.

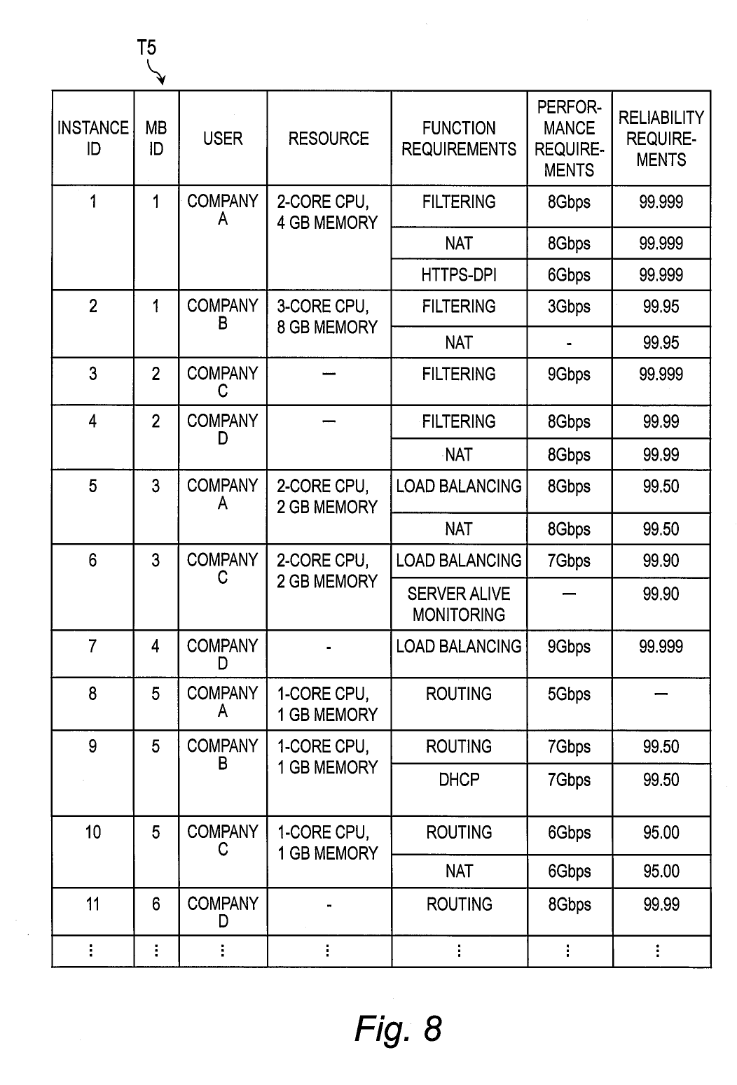

FIG. 8 is an explanatory diagram illustrating an example of what is stored in the MB instance Table T5. The MB instance Table T5 is a table in which MB requirements from users are registered. The MB instance Table T5 includes an instance ID field, an MB ID field, a user field, a resource field, a function requirements field, a performance requirements field, and a reliability requirements field, and holds values of the respective fields for each MB instance.

The instance ID field stores in each entry an instance ID. The instance ID is identification information for uniquely identifying an MB instance. When receiving MB requirements, the network management apparatus 2 generates a new entry in the MB instance Table T5 and assigns a unique instance ID to the entry.

The user field stores in each entry the name of a user who has sent MB requirements. The resource field stores in each entry information on resources of the MB 4 that is identified by an MB ID registered in the entry. The information on resources registered in an entry indicates the amount of computer resources such as the CPU 302 and the memory 304 that are allocated to the MB instance of the entry. When creating an entry in the MB instance Table T5, the network management apparatus 2 refers to the second know-how table T22 to extract performance characteristics from an entry of the second know-how table T22 that holds an MB ID matching the MB ID in the created entry, and stores the performance characteristics in the resource field of the MB instance Table T5. No value is stored in the resource field in an entry where the MB instance is a physical MB.

The function requirements field stores in each entry function requirements. The function requirements are functions of the MBs 4 that a user requires of the MB 4 to be allocated to the user. The performance requirements field stores in each entry performance requirements. The performance requirements are performance of the MBs 4 that a user requires of MB 4 to be allocated to the user. The reliability requirements field stores in each entry reliability requirements. The reliability requirements are reliability values of the MBs 4 that a user requires of the MB 4 to be allocated to the user.

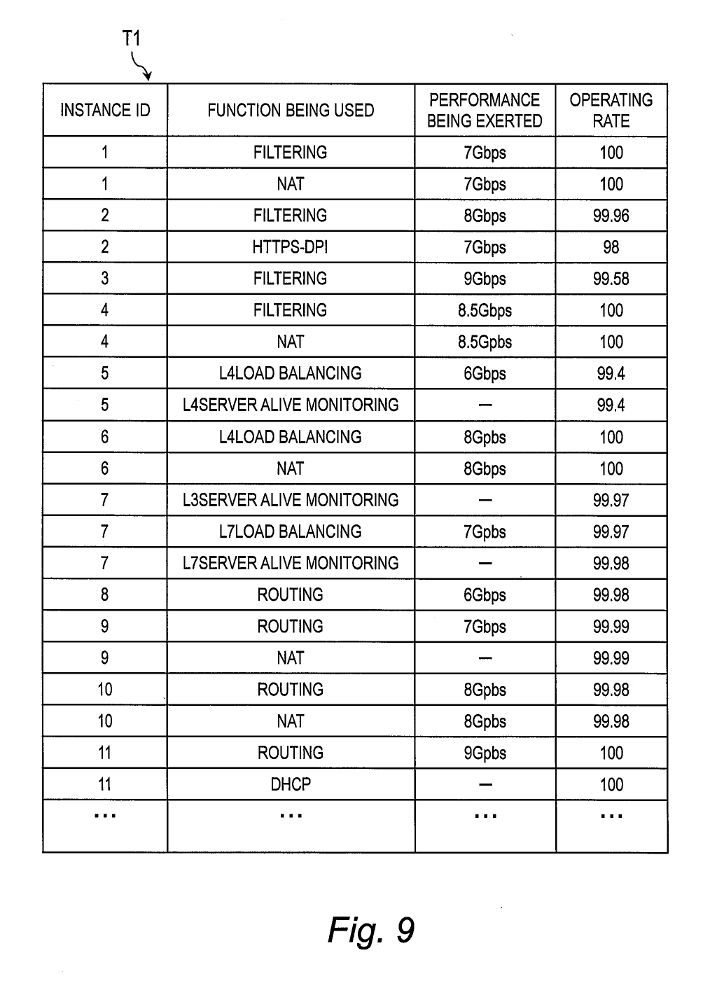

FIG. 9 is an explanatory diagram illustrating an example of what is stored in the MB instance operational status table T1. The MB instance operational status table T1 is a table in which information of an MB instance that is in operation is updated sequentially. The MB instance operational status table T1 includes an instance ID field, a function-being-used field, a performance-being-exerted field, and an operating rate field, and stores values of the respective fields for each MB instance.

The function-being-used field stores in each entry a function being used. The function being used that is registered in an entry is a function being enabled in the MB instance of the entry. The performance-being-exerted field stores in each entry performance being exerted. The performance being exerted registered in an entry is the actual performance value of performance being exerted by a function being used that is registered in the entry. The value of the performance being exerted is the latest value, an average value, the highest value, the lowest value, a median, or the like, which is set depending on the user or the provider. The operating rate field stores in each entry the operating rate of the MB instance of the entry. The operating rate of an MB instance is a rate at which a function of the MB instance that is in use has been in operation. An average of the operating rates of MB instances in the same MB constitutes the actual reliability value of FIG. 7.

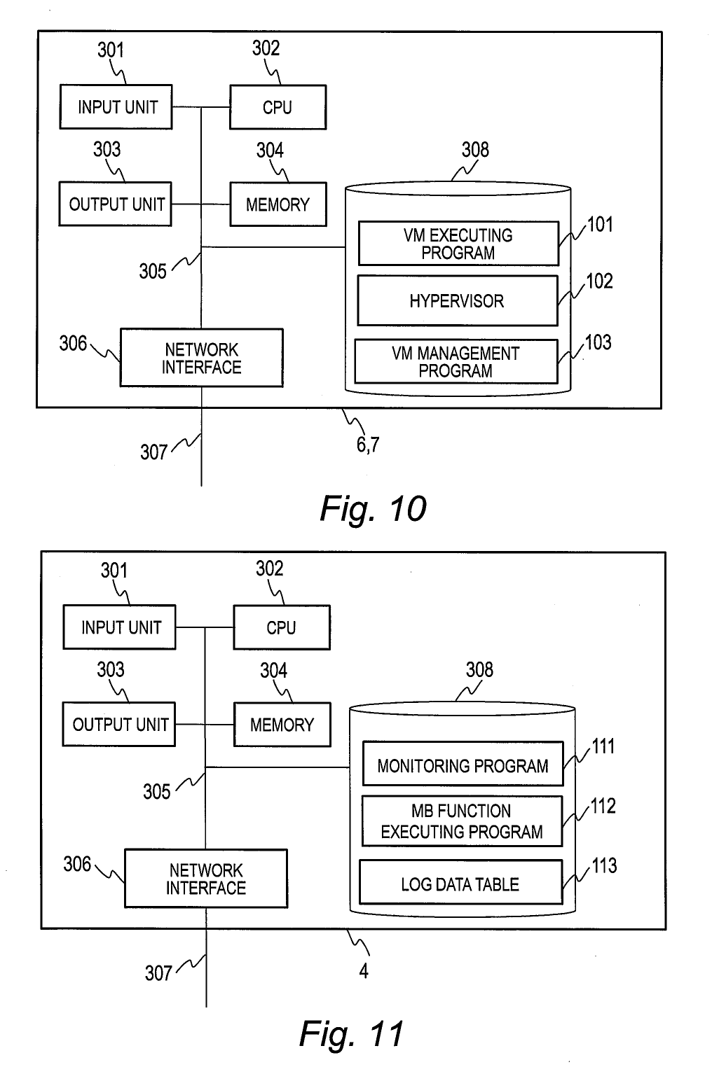

FIG. 10 is a block diagram illustrating a hardware configuration example of each of the server 6 and the VM management apparatus 7. Other components than ones stored in the storage apparatus 308 are the same as the components of FIG. 3, and descriptions thereof are omitted here.

The server 6 and the VM management apparatus 7 each store, in the storage apparatus 308, a VM executing program 101, a hypervisor 102, and a VM management program 103. The VM executing program 101 is a program that executes virtual MBs, which are virtual machines. The hypervisor 102 cooperates with the VM management program 103 in executing or deleting virtual machines and executing or deleting virtual switches. The VM management program 103 receives a request for the cooperation from another apparatus via the network interface 306, and then issues an instruction to the hypervisor 102.

FIG. 11 is a block diagram illustrating a hardware configuration example of each MB 4. Other components than ones stored in the storage apparatus 308 are the same as the components of FIG. 3, and descriptions thereof are omitted here. Each MB 4 stores, in the storage apparatus 308, a monitoring program 111, an MB function executing program 112, and a log data table 113. The monitoring program 111 monitors a function of the MB 4 that is executed by the MB function executing program 112, and performance being exerted by this function, saves results of the monitoring in the log data table 113, and transmits the log data table 113 to the network management apparatus 2.

The MB function executing program 112 executes functions of the various MBs 4 such as filtering in a firewall, load balancing in a load balancer, and routing in a router. Each type of MB 4 may have only some of functions that are associated with the type.

The access-use apparatus 11 has components (not shown) that are also the same as those of the apparatus illustrated in FIG. 3, except for components stored in the storage apparatus 308. The access-use apparatus 11 stores in the storage apparatus 308 a program for transmitting requests to the respective programs that are stored in the storage apparatus 308 of the network management apparatus 2. This program transmits commands or requests input by a user of the access-use apparatus 11 to, for example, command line interfaces (CLIs) or graphical user interfaces (GUIs) that the programs of the network management apparatus 2 execute.

<Overall Sequence Example>

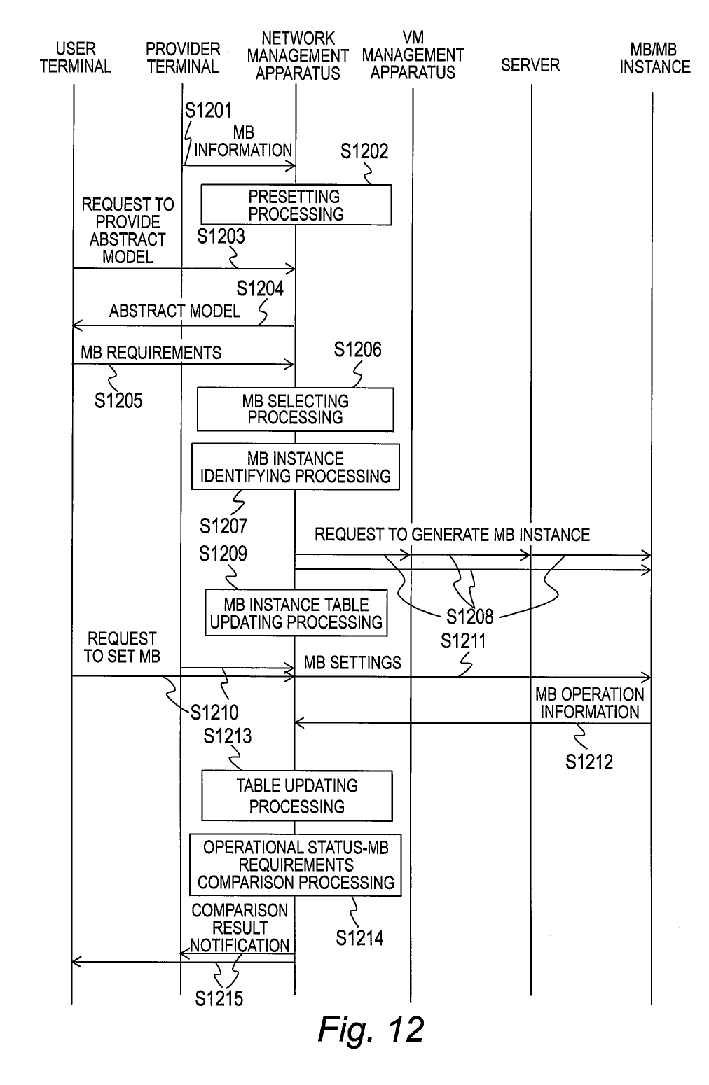

FIG. 12 is a sequence diagram illustrating an example of an overall sequence in the MB management system 100. First, the provider terminal 3 transmits MB information to the network management apparatus 2 in order to set the various tables (Step S1201). To give a concrete example, the MB information includes reference functions of the MBs 4, reference performance values of the MBs 4, and the reference reliability values of the MBs 4, which are used to set the MB abstract model table T3. The MB information also includes the model names of the MBs 4, the types of the MBs 4, and the modes of the MBs 4, which are used for the presetting of the MB model table T4. The MB information may in some cases include interconnection know-how, which is used to set the first know-how table T21. The MB information further includes corresponding functions, actual performance, performance characteristics, actual reliability, and reliability securing methods, which are used to preset the second know-how table T22.

The network management apparatus 2 uses the MB information transmitted in Step S1201 to execute presetting processing (Step S1202). The presetting processing is processing of reflecting the MB information transmitted in Step S1201 in the tables T3, T4, T21, and T22, which are illustrated in FIGS. 4 to 7.

In the case where the MB information includes a model name “Vendor a firewall”, a type “firewall”, and a mode “virtual”, for example, the network management apparatus 2 stores those pieces of MB information in the model name filed, type field, and mode field of the MB model table T4, respectively, issues a unique MB ID, and stores the MB ID in the MB ID field. In this manner, the network management apparatus 2 can execute various types of processing such as MB selection and MB instance generation when a request to provide MB abstract models is transmitted from the user terminal 1 of the user.

In the case where the user wishes to be provided with MB abstract models, the user terminal 1 subsequently transmits a request to provide MB abstract models to the network management apparatus 2 (Step S1203). The network management apparatus 2 receives the request to provide MB abstract models and transmits the MB abstract model table T3 to the user terminal 1 (Step S1204).

In Step S1205, requirement obtaining processing is executed in which the network management apparatus 2 obtains MB requirements from the user terminal 1. The user refers to the MB abstract model table T3 to input MB requirements, which are conditions of an MB that the user wishes to use, into the user terminal 1. The user terminal 1 transmits the input MB requirements to the network management apparatus 2 (Step 1205). The MB requirements are conditions that a user requires of an MB that the user wishes to use, and are expressed in the form of, for example, a wish to use a firewall and a router that are presented in MB abstract models, or a wish for an MB that has higher performance and reliability than those presented in MB abstract models.

The network management apparatus 2 receives the MB requirements and executes MB selecting processing (Step S1206). The MB selecting processing (Step S1206) is processing of selecting the MB 4 that fulfills MB requirements. Details of the MB selecting processing (Step S1206) are described later. Through the MB selecting processing (Step S1206), an MB that takes MB requirements into account is set.

The network management apparatus 2 executes MB instance identifying processing (Step S1207) for the MB selected in the MB selecting processing (Step S1206). The MB instance identifying processing (Step S1207) is processing of identifying an MB instance to be generated, based on the selected MB 4, and creating a request to generate the identified MB instance.

For example, the provisioning program 314 of the network management apparatus 2 identifies the mode of implementing the selected MB 4 by referring to the mode field of the MB model table T4. The provisioning program 314 refers to the performance characteristics field and reliability securing method field of the second know-how table T22 to identify the amount of resources to be allocated and a reliability securing method to be used. The network management apparatus 2 then transmits an MB instance generating request that includes those pieces of identified information (Step S1208).

In the case where the MB instance to be generated is an MB instance of a virtual MB, for example, the network management apparatus 2 transmits the MB instance generating request to the VM management apparatus 7 along with the amount of resources to be allocated. In the case where the reliability securing method identified uses a virtual server high availability (HA) function, the network management apparatus 2 further requests to execute this function. Receiving the request to execute the function, the VM management apparatus 7 generates a virtual MB to which the notified resource amount is allocated on the server 6, and executes the HA function.

In the case where the MB instance to be generated is an MB instance of a physical MB, on the other hand, the provisioning program 314 selects the MB 4 from the MB group 5 and transmits an MB instance generating request to the selected MB 4. In the case where the reliability securing method identified uses an instance redundancy providing function, the network management apparatus 2 further requests to execute this function. Receiving the request to execute the function, the MB 4 executes an apparatus redundancy providing function. The MB instance is generated in this manner. Step S1207 and Step S1208 thus constitute MB instance generating processing in which an MB instance is generated.

The network management apparatus 2 then updates the MB instance table T5 with respect to the generated MB instance (Step S1209). Specifically, the network management apparatus 2 adds an entry for the generated MB instance to the MB instance table T5. More specifically, the provisioning program 314 of the network management apparatus 2 stores the MB ID of the MB 4 selected in Step S1206 and the sender of the MB requirements (the user) in the MB ID field and the user field of the MB instance table T5, respectively.

In the case where a virtual MB is generated in Step S1208, the provisioning program 314 stores the allocated resource amount in the resource field of the MB instance table T5, issues a unique ID, and stores the ID in the instance ID field.

The provisioning program 314 further stores the user's requirements in the function requirements field, performance requirements field, and reliability requirements field of the MB instance table T5. In the case where a virtual MB is not generated in Step S1208, i.e., when the selected MB is a physical MB, no value is stored in the resource field and the provisioning program 314 only stores a unique ID in the instance ID field.

By updating the respective fields of the MB instance table T5 in this manner, an association relation of the ID of an MB model for which an instance is generated, the user of the MB instance, an allocated resource amount, and the user's requirements is registered in the MB instance table T5 in association with the ID of the MB instance, as illustrated concretely in FIG. 8.

Thereafter, the network management apparatus 2 receives a request to set the MB from the user terminal 1 or the provider terminal 3 (Step S1210). The setting request includes setting parameters of a function to be enabled in the MB 4. Setting parameters include, for example, parameters related to filtering which is to be enabled in a firewall (the source address, the destination address, communication permitted/prohibited), or parameters related to load balancing which is to be enabled in a load balancer (e.g., information about round robin such as a time slice).

The network management apparatus 2 receives the setting request in Step S1210 and enables settings by transmitting the setting request to the MB 4 that is requested to be set by the request (Step S1211). To give a concrete example, the provisioning program 314 extracts setting parameters from the setting request, and gives instruction to a setting interface of the MB 4. The setting interface is, for example, a CLI or an application programmable interface (API), and is included in the MB function executing program 112. The MB function executing program 112 executes processing such as its own filtering or load balancing depending on the received setting parameters. This puts the MB instance in operation.

The network management apparatus 2 then obtains operation information from the MB instance (Step S1212). The operation information is the log data table 113 within the MB instance. The MB instance saves its own operational status in the log data table 113 as log data. Each MB transmits the log data table 113 to the network management apparatus 2 at an interval that can be set arbitrarily. In the case where the setting request of Step S1211 includes a transmission interval setting “1 second”, for example, the MB instance may transmit the log data table 113 at this transmission interval. Alternatively, the network management apparatus 2 may transmit a request to obtain the log data table 113 to each MB 4 at an arbitrary interval so that the MB instance that receives the request transmits the log data table 113 to the network management apparatus 2 in response to the request. Step S1212 thus constitutes operational status obtaining processing in which the operational status of an MB instance is obtained. The network management apparatus 2 obtains the operation information from the MB instance and executes table updating processing (Step S1213). In the table updating processing (Step S1213), the network management apparatus 2 uses the MB instance operational status monitoring program 315 and the received operation information to update the MB instance operational status table T1. The network management apparatus 2 also updates the value of the actual performance field and the value of the actual reliability field in the second know-how table T22.

The network management apparatus 2 compares the obtained operation information with MB requirements that are stored in the MB instance table T5 in association with the MB instance that has transmitted this operation information (Step S1214). The network management apparatus 2 notifies the result of the comparison in Step S1214 to the user terminal 1 or the provider terminal 3 (Step S1215). The comparison result may be information that includes the operation information and the MB requirements, or may be information that indicates a differential between the two. In the case where the MB requirements are held by the user terminal 1 or the provider terminal 3 from which the MB requirements have been transmitted, the network management apparatus 2 may transmit the operation information alone to the user terminal 1 or the provider terminal 3.

<Example of Processing Steps of Updating the Second Know-how Table T22>

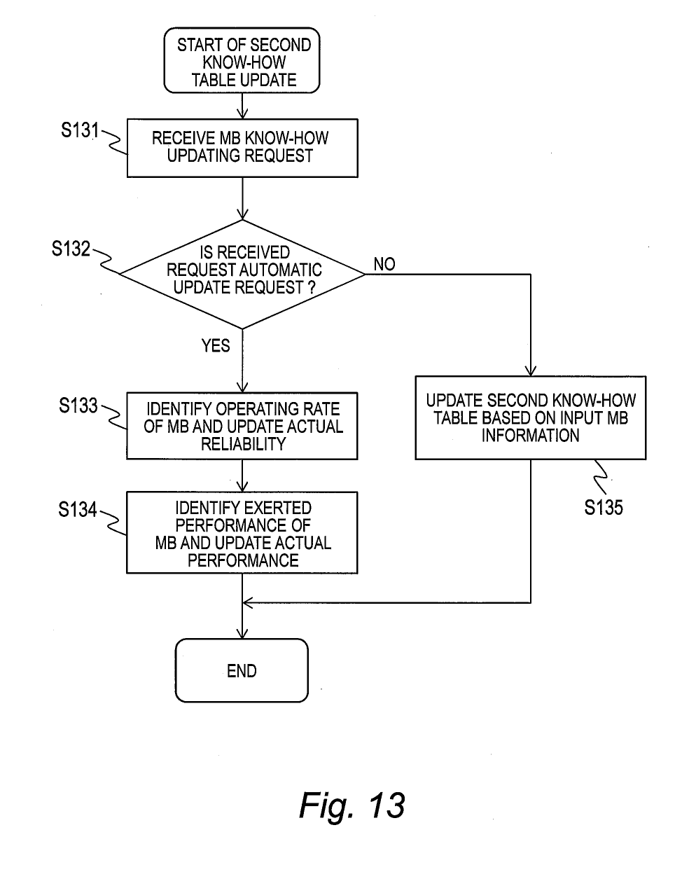

FIG. 13 is a flow chart illustrating an example of processing steps of updating the second know-how table T22, which is illustrated in FIG. 7. The network management apparatus 2 receives a request to update MB know-how (Step S131). For instance, the MB know-how management program 312 receives, via the CLI or the GUI, an MB know-how updating request directed to the CLI or the GUI from the access-use apparatus 11, or from another program.

The network management apparatus 2 next determines whether the MB know-how updating request is an automatic update request (Step S132). The network management apparatus 2 proceeds to Step S133 when the answer to Step S132 is yes, and proceeds to Step S135 when the answer to Step S132 is no. For example, the network management apparatus 2 proceeds to Step S135 in the case where MB information received in Step S131 is from the provider terminal 3, and proceeds to Step S133 when the received request is an automatic update request from the MB instance operational status monitoring program 315.

In the case where the MB information has been transmitted from the provider terminal 3 (Step S132: No), the network management apparatus 2 refers to the MB information received in Step S131 from the provider terminal 3, updates the values of fields in the second know-how table T22 that correspond to the MB information (Step S135), and ends the processing.

In the case where the received request is an automatic update request from the MB instance operational status monitoring program 315 (Step S132: Yes), on the other hand, the network management apparatus 2 identifies the operating rate of the MB instance in question and updates the actual reliability in the second know-how table T22 (Step S133). To give a concrete example, the network management apparatus 2 first refers to the MB instance operational status table T1 to obtain a function being used and an operating rate from an entry that holds an instance ID included in the MB know-how updating request. In the example of FIG. 9, when the instance ID included in the MB know-how updating request is “1”, a function-being-used “filtering” and an operating rate “100%” are obtained.

The network management apparatus 2 refers to the MB instance table T5 to obtain an MB ID from an entry that holds the instance ID included in the MB know-how updating request. In the example given above, an MB ID “1” which is associated with the instance ID “1” is obtained.

The network management apparatus 2 refers to the second know-how table T22 to identify an entry where the registered MB ID is the obtained MB ID and the registered reference function class is the obtained function-being-used. The network management apparatus 2 uses the obtained operating rate to update the actual reliability in the identified entry. For example, the network management apparatus 2 uses an average value of the actual reliability in the identified entry and the obtained operating rate as the updated actual reliability.

In the example given above, actual reliability “96%” is obtained from an entry of the second know-how table T22 where the MB ID is “1” and the reference function class is “filtering”. The actual reliability “96%” is therefore updated to, for example, an average value “98%” of the actual reliability “96%” and the operating rate “100%”.

The network management apparatus 2 executes similar processing for other entries that have the same instance ID in Step S133, thereby updating the actual reliability for all functions-being-used of the same instance. In the example of FIG. 9, where “NAT” is also a function being used that is associated with the instance ID “1” besides “filtering”, the network management apparatus 2 similarly updates the operating rate for a function-being-used “NAT”. The network management apparatus 2 executes the update for entries that hold other instance IDs by accordingly changing the instance ID that serves as a search key.

The network management apparatus 2 next identifies performance being exerted of the MB and updates the actual performance (Step S134). To give a concrete example, the network management apparatus 2 first refers to the MB instance operational status table T1 to obtain a function being used and performance being exerted from an entry that holds the instance ID included in the MB know-how updating request. In the example of FIG. 9, when the instance ID included in the MB know-how updating request is “1”, the function-being-used “filtering” and performance being exerted “7 Gbps” are obtained.

The network management apparatus 2 refers to the MB instance table T5 to obtain an MB ID from an entry that holds the instance ID included in the MB know-how updating request. In the example given above, the MB ID “1” which is associated with the instance ID “1” is obtained.

The network management apparatus 2 refers to the second know-how table T22 to identify an entry where the registered MB ID is the obtained MB ID and the registered reference function class is the obtained function-being-used. The network management apparatus 2 uses the obtained performance being exerted to update the actual performance in the identified entry. For example, the network management apparatus 2 uses an average value of the actual performance in the identified entry and the obtained performance being exerted as the updated actual performance.

In the example given above, actual performance “8 Gbps” is obtained from an entry of the second know-how table T22 where the MB ID is “1” and the reference function class is “filtering”. The actual performance “8 Gbps” is therefore updated to, for example, an average value “7.5 Gbps” of the actual performance “8 Gbps” and the performance being exerted “7 Gbps”.

The network management apparatus 2 subsequently compares the operational status of the MB instance and the MB requirements as illustrated in Step S1214 of FIG. 12, and notifies the result to the provider terminal 3 or the user terminal 1. This notification is used by the user in determining whether the MB 4 selected in Step S1206 is appropriate in light of the MB requirements or for other purposes. Whether the selected MB 4 is appropriate can be checked from the operational status of the MB instance by checking, for example, whether the MB instance fulfills the performance requirements, fulfills the reliability requirements, and is using all of required functions. A description thereof is given below by way of concrete examples.

(Result of Comparison Between the Operating Rate of the MB Instance and Reliability Requirements)

For example, the network management apparatus 2 identifies an entry of the MB instance table T5 that holds the instance ID used to obtain the operating rate in Step S133, and function requirements that include the function being used, and obtains a reliability requirement from the identified entry.

A case where the instance ID used in Step S133 is “1” and the function being used is “filtering” is described as a concrete example. The network management apparatus 2 identifies an entry of the MB instance table T5 of FIG. 8 where the instance ID is “1” and a function requirement “filtering” is included. The network management apparatus 2 obtains a reliability requirement “99.999%” from the identified entry. The network management apparatus 2 has obtained in Step S133 the operating rate “100%”, which is identified from the instance ID “1” and the function-being-used “filtering”. Accordingly, the network management apparatus 2 notifies the result of a comparison between the operating rate “100%” and the reliability requirement “99.999%” of the identified entry.

(Result of Comparison Between the Performance being Exerted of the MB Instance and Performance Requirements)

The network management apparatus 2 also identifies an entry of the MB instance table T5 that holds the instance ID used to obtain the performance being exerted in Step S134, and function requirements that includes the function being used, and obtains a performance requirement from the identified entry.

A case where the instance ID used in Step S134 is “1” and the function being used is “filtering” is described as a concrete example. The network management apparatus 2 identifies an entry of the MB instance table T5 of FIG. 8 where the instance ID is “1” and a function requirement “filtering” is included. The network management apparatus 2 obtains a performance requirement “8 Gbps” from the identified entry. The network management apparatus 2 has obtained in Step S134 the performance being exerted “7 Gbps”, which is identified from the instance ID “1” and the function-being-used “filtering”. Accordingly, the network management apparatus 2 notifies the result of a comparison between the performance being exerted “7 Gbps” and the performance requirement “8 Gbps” of the identified entry.

The network management apparatus 2 may determine that the performance being exerted cannot reach the actual performance with a resource amount identified from the performance characteristics in the second know-how table T22, in the case where the MB instance in question is a virtual MB and a relation “performance being exerted<actual performance” applies. The network management apparatus 2 in this case may update the table so that the resource amount identified from the performance characteristics in the second know-how table T22 is larger. For example, the resource amount identified by the performance characteristics may be updated automatically from “2-core CPU, 4 GB memory” to “3-core CPU, 8 GB memory”. Alternatively, the network management apparatus 2 may notify the provider terminal 3 of the fact that the performance being exerted has failed to reach the actual performance. The network management apparatus 2 in this case may update the performance characteristics in response to an instruction from the provider terminal 3.

(Checking Whether a Required Function is in Use or not)

The network management apparatus 2 checks whether a required function is in use or not for the instance ID used in the comparison between the operating rate of the MB instance and the reliability requirements, and in the comparison between the performance being exerted of the MB instance and the performance requirements. Specifically, the network management apparatus 2 refers to the MB instance operational status table T1 to obtain all functions being used from an entry that holds the instance ID included in the MB know-how updating request. In the example given above, where the instance ID is “1”, the function-being-used “filtering” and the function-being-used “NAT” are obtained.

The network management apparatus 2 next refers to the MB instance table T5 to obtain, as fulfilled function requirements, function requirements that match the functions-being-used obtained in the preceding step, and to obtain, as unfulfilled function requirements, function requirements that do not match the obtained functions-being-used. In the example given above, FIG. 8 shows that function requirements of an MB instance whose instance ID is “1” are “filtering”, “NAT”, and “HTTPS-DPI”, and fulfilled function requirements are accordingly “filtering” and “NAT”, whereas “HTTPS-DPI” is an unfulfilled function requirement.

The network management apparatus 2 can identify for every instance ID whether a required function is in use or not by executing a comparison between the operating rate of an MB instance and reliability requirements and a comparison between performance being exerted of the MB instance and performance requirements for other instance IDs.

In this manner, the network management apparatus 2 notifies the result of the comparison between the operating rate of the MB instance and the reliability requirements, the result of the comparison between the performance being exerted and the performance requirements, and whether a required function is in use or not to the user terminal 1 or the provider terminal 3. The settings of the notification may be varied. For instance, the notification may be set so that the provider alone, the user alone, or the like is notified, the notification interval may be set to “immediately after the determination”, “a month after the determination”, or the like, and the condition for notification may be set so that the notification is made when the number of accomplished requirements, the number of unaccomplished requirements, the number of requirements that are not in use, or the like reaches a threshold or higher. Alternatively, default settings may be set to the notification.

<Example of Processing Steps of Updating the MB Abstract Model Table T3>

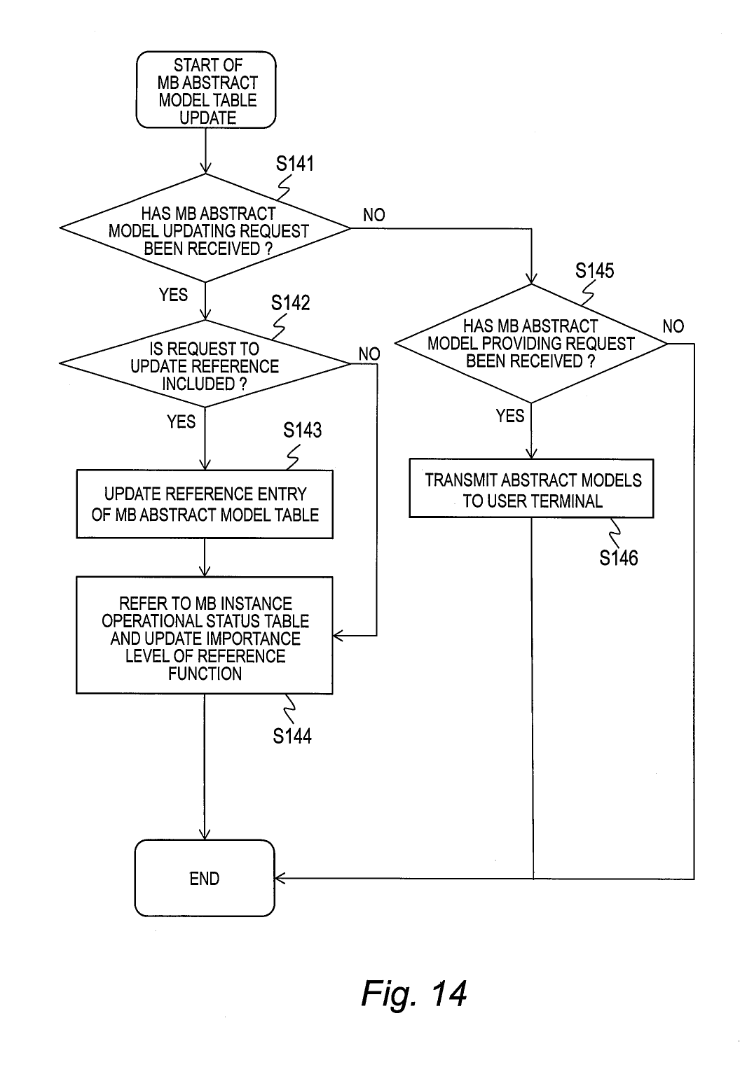

FIG. 14 is a flow chart illustrating an example of processing steps of updating the MB abstract model table T3. The network management apparatus 2 determines whether or not a request to update the MB abstract model table T3 has been received (Step S141) and, in the case where the updating request has been received (Step S141: Yes), proceeds to Step S142. In the case where what has been received is not the updating request (Step S141: No), the network management apparatus 2 proceeds to Step S145. The updating request is input from, for example, the access-use apparatus 11 and received by the MB abstract model management program 311 through the function of the CLI or the GUI.

When it is determined in Step S141 that a request to update the MB abstract model table T3 has been received (Step S141: Yes), and the updating request includes a request to update reference (the reference reliability value, the reference performance value, and the reference function class) (Step S142: Yes), the network management apparatus 2 proceeds to Step S143. In the case where the request to update reference is not included (Step S142: No), the network management apparatus 2 proceeds to Step S144.

In Step S143, the network management apparatus 2 updates some of the reference fields of the MB abstract model table T3 that are included in the updating request (Step S143). The method of updating varies depending on the reference type. The reference reliability value and the reference performance value are updated by, for example, inputting new values into the reference reliability value field and the reference performance value field from the provider terminal 3. To update the reference function class, the network management apparatus 2 refers to the reference function class in the second know-how table T22 and, when there is a difference from the reference function class of the MB abstract model table T3, updates the MB abstract model table T3 so that the reference function class of the MB abstract model table T3 matches the reference function class of the second know-how table T22.

The network management apparatus 2 then updates the importance level of the reference function class of the MB abstract model table T3 (Step S144), and ends the processing. Specifically, the network management apparatus 2 refers to the MB instance operational status table T1 to identify, for each MB instance, functions being used. For each MB type of the identified functions-being-used, the network management apparatus 2 calculates the proportion of MB instances in which the function being used is enabled, and sets “A” as the importance level of a function that has a high proportion and “B” or “C” as the importance level of a function that has a low proportion.

To give a concrete example, of MB instances that have instance IDs “1” to “4” in the MB instance operational status table T1, filtering and NAT are enabled in the MB instance having the instance ID “1”, filtering and HTTPS-DPI are enabled in the MB instance having the instance ID “2”, filtering is enabled in the MB instance having the instance ID “3”, and filtering and NAT are enabled in the MB instance having the instance ID “4”. The network management apparatus 2 determines the importance level of filtering, which is enabled in all of the MB instances, as “A”, determines the importance level of NAT, which is enabled in two of the MB instances, as “B”, and determines the importance level of HTTPS-DPI, which is enabled in only one of the MB instances, as “C”. Determining the importance level based on proportion is given as an example, and other methods may be set as the method of determining the importance level.

In the case where a request to provide the MB abstract model table T3 has been received in Step S141 (Step S141: No), the network management apparatus 2 proceeds to Step S145. In the case where what has been received in Step S141 is not a request to provide the MB abstract model table T3 (Step S145: No), the network management apparatus 2 ends the processing without performing anything particular. In the case where what has been received is the providing request (Step S145: Yes), on the other hand, the network management apparatus 2 transmits the MB abstract model table T3 to the user terminal 1 that has sent the request to provide the MB abstract model table T3 (Step S146). The network management apparatus 2 transmits the MB abstract model table T3 as, for example, a response to a request to the CLI or GUI of the MB abstract model management program 311.

<Example of Processing Steps of Updating the MB Instance Operational Status Table T1>

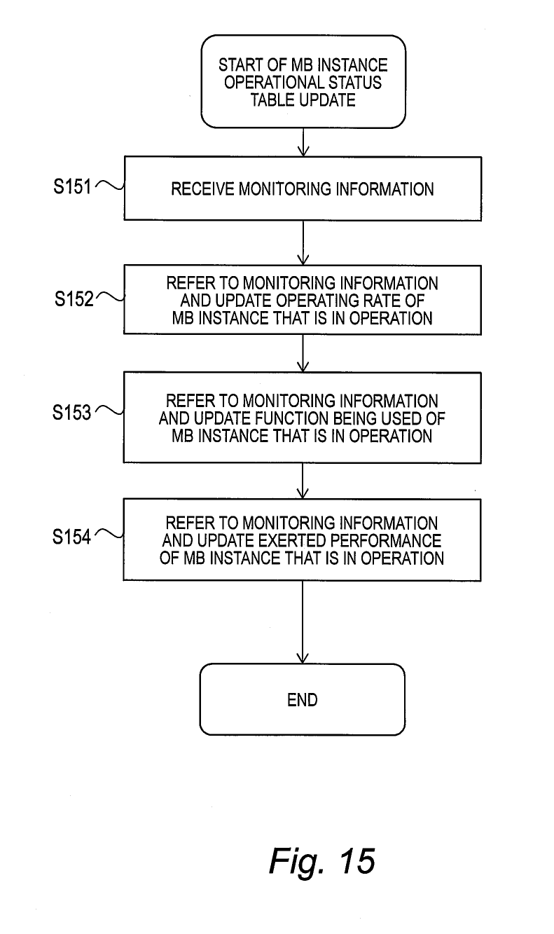

FIG. 15 is a flow chart illustrating an example of processing steps of updating the MB instance operational status table T1. The network management apparatus 2 receives monitoring information from an MB instance (Step S151). The monitoring information is specifically the log data table 113 generated by the MB instance, for example. The log data table 113 includes functions being used, performance being exerted of the functions being used, a time at which the MB instance has stopped running (a time at which a failure has occurred), and the like.

The network management apparatus 2 next refers to the monitoring information to update the operating rate field in an entry of the MB instance operational status table T1 that is associated with the MB instance from which the monitoring information has been transmitted (Step S152). For example, the network management apparatus 2 calculates a time elapsed since the start of operation which is a differential between a time at which the monitoring information has been obtained and a time at which the MB instance has started operating. The network management apparatus 2 calculates the ratio of the time elapsed since the start of operation and a time obtained by subtracting a period where the MB instance has stopped running due to a failure or the like from the time elapsed since the start of operation. The calculated ratio is the operating rate.

The network management apparatus 2 refers to the monitoring information to update a function being used in the MB instance operational status table T1 that is associated with the MB instance from which the monitoring information has been transmitted (Step S153). Specifically, the function being used is identified from among the log data table 113, for example.

The network management apparatus 2 then refers to the monitoring information to update a performance being exerted in the MB instance operational status table T1 that is associated with the function being used by the MB instance from which the monitoring information has been transmitted (Step S154). The performance being exerted is included in the log data table 113, which allows the network management apparatus 2 to extract the performance being exerted from the log data table 113. The series of processing is hereby finished.

<Example of Steps of the MB Selecting Processing>

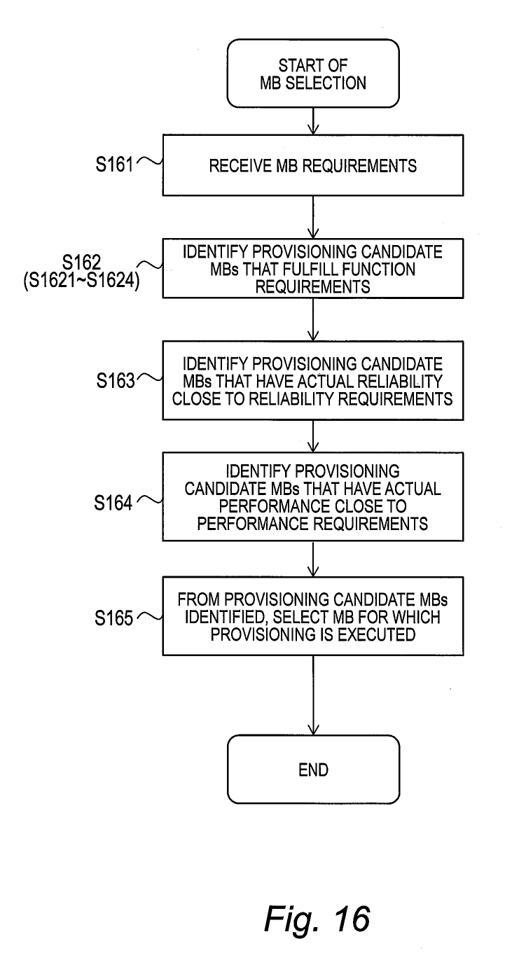

FIG. 16 is a flow chart illustrating an example of steps of the MB selecting processing, which is illustrated in FIG. 12.

S161: The network management apparatus 2 receives MB requirements (Step S161). The MB requirements are received through, for example, the function of the CLI or the GUI that the MB selecting program 313 possesses. The MB requirements may instead be input from the provider terminal 3. Here, it is assumed that the user selects as MB requirements an entry for a load balancer in the MB abstract model table T3 of FIG. 4, and the network management apparatus 2 receives the MB requirements from the user terminal 1. The respective values of the MB requirements may be the same as values stored in the MB abstract model table T3, or may be arbitrary values input from the user terminal 1.

S162: Receiving the MB requirements in Step S161, the network management apparatus 2 identifies provisioning candidate MBs which fulfill function requirements (Step S162). To give a concrete example, the network management apparatus 2 refers to the MB model table T4 to identify, for each type of function requirement included in the received MB requirements, an MB ID that is associated with the type (Step S1621). In the example of the MB requirements given above, where the type of the MB function is “load balancer”, the network management apparatus 2 refers to the MB model table T4 and identifies “3” and “4” as MB IDs that are associated with the type “load balancer”.

The network management apparatus 2 then refers to the second know-how table T22 to identify any entry that holds one of the extracted MB IDs and that has as the reference function class one of the function requirements included in the received MB requirements (Step S1622). In the example given above, where the identified MB IDs are “3” and “4” and the function requirements included in the received MB requirements are “load balancing” and “NAT”, the network management apparatus 2 checks whether the second know-how table T22 includes an entry that has “3” or “4” as the MB ID and “load balancing” or “NAT as the reference function class.

The network management apparatus 2 in this case holds “3” and “4” which are MB IDs registered in entries of the second know-how table T22. In the case where the MB IDs in question are not registered in the second know-how table T22, it means that no MB fulfills the function requirements, and that there are no provisioning candidate MBs.

The network management apparatus 2 next refers to the first know-how table T21 to search for interconnected MB IDs and interconnection information that are associated with the held MB IDs (Step S1623). In the example given above, there are no interconnected MB IDs and interconnection information that are associated with the MB IDs “3” and “4”. Consequently, MBs whose MB IDs are “3” and “4” are identified as provisioning candidate MBs having reference function classes.

In the case where an interconnected MB ID that is associated with one of the held MB IDs is found, the network management apparatus 2 analyzes the relevant interconnection information (Step S1624). For example, when the interconnection information says “chance of communication failure” or the like that indicates that the interconnection in question is not recommended, the network management apparatus 2 refers to the MB instance table T5 and, using the name of the user who has transmitted the MB requirements in Step S161 as a key, identifies whether or not an MB instance that has the found interconnected MB ID has been generated. In the case where an MB instance that has the found interconnected MB ID has been generated, the network management apparatus 2 excludes the MB having this MB ID from provisioning candidate MBs.

S163: The network management apparatus 2 next identifies provisioning candidate MBs that have actual reliability close to reliability requirements (Step S163). The reliability requirements here include a reference reliability value included in the received MB requirements. Actual reliability close to reliability requirements is, for example, actual reliability whose value has a minimum differential from the reliability requirements.

When the actual reliability of only one MB is close to the reliability requirements, or when the differential between the reliability requirements and the actual reliability is the same for a plurality of MBs, the MB or the MBs may be kept as provisioning candidate MBs without condition, or only MBs for which the differential is within a threshold may be kept as provisioning candidate MBs. An MB for which the differential between the reliability requirements and the actual reliability is minimum but is outside a threshold may be excluded from provisioning candidate MBs.

Specifically, the network management apparatus 2 refers to the second know-how table T22 to identify entries where the MB IDs held in Step S1622 are registered and, out of the identified entries, identifies any entry whose reference function class is included in the MB requirements. The network management apparatus 2 then identifies actual reliability registered in the identified entry. The MB IDs held in Step S1622 are “3” and “4”, and a reference function class included in the MB requirements that has the importance level “A” (indicating an indispensable function) is “load balancing”. The network management apparatus 2 accordingly identifies actual reliability “97.00%” registered in an entry where the MB ID is “3” and the reference function class is “load balancing”, and identifies actual reliability “99.70%” registered in an entry where the MB ID is “4” and the reference function class is “load balancing”.

A reference reliability value that is the reliability requirements included in the MB requirements of this example is “99.999” as illustrated in FIG. 4. In the case where the differential from the reference reliability value is within a threshold for the actual reliability of the MB having the MB ID “3” and for the actual reliability of the MB having the MB ID “4”, the MB having the MB ID “3” and the MB having the MB ID “4” both remain provisioning candidate MBs.

S164: The network management apparatus 2 identifies provisioning candidate MBs that have actual performance close to performance requirements (Step S164). The performance requirements here include reference performance values included in the received MB requirements. Actual performance close to performance requirements is, for example, actual performance that has a minimum absolute value of a differential from the performance requirements.

When the actual performance of only one MB is close to the performance requirements, or when the absolute value of the differential between the performance requirements and the actual performance is the same for a plurality of MBs, the MB or the MBs may be kept as provisioning candidate MBs without condition, or only MBs for which the absolute value of the differential is within a threshold may be kept as provisioning candidate MBs. An MB for which the absolute value of the differential of actual performance is minimum but is outside a threshold may be excluded from provisioning candidate MBs.

Specifically, the network management apparatus 2 refers to the second know-how table T22 to identify entries where the MB IDs held in Step S1622 are registered. The network management apparatus 2 then identifies actual performance of each identified entry. The MB IDs held in Step S1622 are “3” and “4”, and a reference function class included in the MB requirements that has the importance level “A” (indicating an indispensable function) is “load balancing”. The network management apparatus 2 accordingly identifies actual performance “7 Gbps” registered in an entry where the MB ID is “3” and the reference function class is “load balancing”, and identifies actual performance “8 Gbps” registered in an entry where the MB ID is “4” and the reference function class is “load balancing”.

A reference performance value that is the performance requirement included in the MB requirements of this example is “7 Gbps” as illustrated in FIG. 4. In this case, of the actual performance “7 Gbps” and the actual performance “8 Gbps”, the absolute value of the differential from the reference performance value “7 Gbps” is minimum for the actual performance “7 Gbps”, and the MB having the MB ID “3” whose actual performance is “7 Gbps” accordingly remains a provisioning candidate MB.

S165: The network management apparatus 2 next selects an MB for which provisioning is to be executed from among the provisioning candidate MBs identified in Step S163 and Step S164 (Step S165). In the example given above, the MB having the MB ID “3” and the MB having the MB ID “4” are identified in Step S163, and the MB having the MB ID “3” is identified in Step S164. The network management apparatus 2 accordingly selects the MB having the MB ID “3” which is identified in both Step S163 and Step S164 as a provisioning target MB.

As provisioning target MBs, the network management apparatus 2 may separately select MBs identified in Step S163 and MBs identified in Step S164. In this example, the MB having the MB ID “3” and the MB having the MB ID “4” are selected as provisioning target MBs.

In the case where different MBs are identified in Step S163 and Step S164, the network management apparatus 2 may select as a provisioning target MB an MB whose actual reliability and actual performance exceed reliability requirements and performance requirements.

For example, when the actual reliability of the MB having the MB ID “4” is “100” in Step S163, the reliability requirement “99.999” is exceeded and the MB having the MB ID “4” is therefore identified. In Step S164, on the other hand, the MB having the MB ID “3” which has actual performance “7 Gbps” is identified in Step S164. In this case, the actual performance “8 Gbps” of the MB having the MB ID “4” exceeds the performance requirement “7 Gbps”, and the network management apparatus 2 selects the MB having the MB ID “4” as a provisioning target MB in Step S164 as well.

In the case where the same combination of MBs is identified in Step S163 and in Step S164, the network management apparatus 2 may select virtual MBs rather than physical MBs as provisioning target MBs.

For example, in the case where the actual performance of the MB having the MB ID “4” is “7 Gbps” in Step S164, the MB having the MB ID “3” and the MB having the MB ID “4” both are identified in Step S163 and in Step S164. The network management apparatus 2 in this case selects the MB having the MB ID “3” as a provisioning target MB because the MB having the MB ID “3” is a virtual MB whereas the MB having the MB ID “4” is a physical MB.

In the case where no MBs are identified or selected in Steps S162 to S165, the network management apparatus 2 may transmit the reason thereof to the user terminal 1 or the provider terminal 3.

The description given above deals with an example in which Step S163 and Step S164 are executed in parallel. Alternatively, Step S164 may be executed for MBs identified in Step S163, and Step S163 may be executed for MBs identified in Step S164. Step S163 and Step S164 do not always need to be executed both, and it may be sufficient if at least one of S163 and S164 is executed.

The user can thus receive MB abstract models from the provider side, and can accordingly determine MB requirements for an MB that the user wishes to use by referring to the MB abstract models. In addition, selecting an MB that fulfills the MB requirements is executed by the network management apparatus 2, which eliminates the need for the user to select the model of the MB. Convenience of the MB selection is thus improved.

The user is also notified of a discrepancy between the operational status of an MB instance and the MB requirements, and can therefore check whether the service provided to the user is as requested. The notification can further be used to present MB requirements anew when it is necessary.

This embodiment where the network management apparatus 2 automatically executes the MB selection benefits the providers as well by lessening the load of the MB selection. In particular, the providers give operation know-how to the network management apparatus 2, thereby enabling the network management apparatus 2 to take into account the operation know-how when selecting an MB. Knowledge about compatibility between MBs which is acquired through operation can thus be used in the selecting of an MB, with the result that the reliability of the selected MB is improved. The provider is also notified of a discrepancy between the operational status of an MB instance and the MB requirements, which makes it easy for the provider to determine whether the current operation know-how or reference is appropriate.

According to the embodiment, the MB selection can be facilitated. Thus it is possible for MB providers to provide the network specification coupled with MB function, reliability, and performance. The MB selection which matches MB requirements can be facilitated for users, and the determining the adequacy of the selected MB for the requirements can be facilitated.

In the embodiment, the MB selection is executed to use MB function, reliability, and performance. The MB selection may be executed to use at least one of MB function, reliability, and performance.

It should be noted that this invention is not limited to the above-mentioned embodiments, and encompasses various modification examples and the equivalent configurations within the scope of the appended claims without departing from the gist of this invention. For example, the above-mentioned embodiments are described in detail for a better understanding of this invention, and this invention is not necessarily limited to what includes all the configurations that have been described. Further, a part of the configurations according to the embodiment may be added to, deleted from, or replaced by another configuration.

Further, a part or entirety of the respective configurations, functions, processing modules, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

Although the present disclosure has been described with reference to example embodiments, those skilled in the art will recognize that various changes and modifications may be made in form and detail without departing from the spirit and scope of the claimed subject matter.

What is claimed is:

1. A management apparatus for managing a group of network apparatus each being configured to implement a type selected from a plurality of types,
the management apparatus being configured to:
manage, for each network apparatus in the group, information comprising at least one of a function identified by the selected type, an actual value of performance that is exerted when the function is enabled, or an actual value of reliability that is exerted when the function is enabled; and
execute:
requirement obtaining processing of obtaining at least one requirement out of a function requirement, a performance requirement, and a reliability requirement that are required of the type selected from the plurality of types; and
selection processing of selecting from the group a network apparatus that fulfills the at least one requirement obtained in the requirement obtaining processing, by referring to the information that is stored.

2. The management apparatus according to claim 1,
wherein the management apparatus further stores information about compatibility between the network apparatus, and
wherein, in the selection processing, the management apparatus selects a network apparatus that fulfills the at least one requirement from the group based on the information about compatibility.

3. The management apparatus according to claim 1, wherein the management apparatus executes:
generation processing of generating an instance of the network apparatus that has been selected in the selection processing, by setting the selected network apparatus so that the selected type implements the at least one requirement obtained in the requirement obtaining processing;
operational status obtaining processing of obtaining, from the instance generated by the generation processing, information that indicates an operational status of the generated instance when the generated instance is put into operation; and
notification processing of notifying the information that indicates the operational status and that has been obtained in the operational status obtaining processing to a sender of the at least one requirement obtained in the requirement obtaining processing.

4. The management apparatus according to claim 3,
wherein the management apparatus executes comparison processing of comparing the at least one requirement obtained in the requirement obtaining processing and the information that indicates the operational status and that has been obtained in the operational status obtaining processing, and
wherein, in the notification processing, the management apparatus notifies a comparison result of the comparison processing to the sender.

5. The management apparatus according to claim 4,
wherein, in the operational status obtaining processing, the management apparatus obtains a value that indicates reliability of a function enabled and exerted in the generated instance from the generated instance as the information that indicates the operational status, and
wherein, in the comparison processing, the management apparatus compares a value that indicates reliability required of the selected type and that has been obtained in the requirement obtaining processing with a value that indicates reliability and that has been obtained in the operational status obtaining processing.

6. The management apparatus according to claim 4,
wherein, in the operational status obtaining processing, the management apparatus obtains a value that indicates performance of a function enabled and exerted in the generated instance from the generated instance as the information that indicates the operational status, and
wherein, in the comparison processing, the management apparatus compares a value that indicates performance required of the selected type and that has been obtained in the requirement obtaining processing with a value that indicates performance and that has been obtained in the operational status obtaining processing.

7. The management apparatus according to claim 4,
wherein, in the operational status obtaining processing, the management apparatus obtains information that indicates a function enabled and exerted in the generated instance from the generated instance as the information that indicates the operational status, and
wherein, in the comparison processing, the management apparatus compares information that indicates a function required of the selected type and that has been obtained in the requirement obtaining processing with information that indicates a function and that has been obtained in the operational status obtaining processing.

8. The management apparatus according to claim 4, wherein the management apparatus executes updating processing of updating the stored information based on the information that indicates the operational status and that has been obtained in the operational status obtaining processing.

9. The management apparatus according to claim 1,
wherein the management apparatus further stores, for each type out of the plurality of types, reference information comprising at least one of a reference value for reliability, a reference value for performance, or a function that serves as reference,
wherein, when receiving a request to provide the reference information, the management apparatus executes transmission processing of transmitting the reference information to a sender of the providing request, and
wherein, in the requirement obtaining processing, as a result of transmitting the reference information in the transmission processing, the management apparatus obtains the at least one requirement from the sender of the providing request.

10. A management method to be carried out by a management apparatus for managing a group of network apparatus each being configured to implement a type selected from a plurality of types,
the management apparatus storing, for each network apparatus in the group, information comprising at least one of a function identified by the selected type, an actual value of performance that is exerted when the function is enabled, or an actual value of reliability that is exerted when the function is enabled,
the management method comprising:
obtaining at least one requirement out of a function requirement, a performance requirement, or a reliability requirement that are required of the type specified from the plurality of types; and
selecting from the group a network apparatus that fulfills the obtained at least one requirement by referring to the information that is managed.

11. A management program for controlling a processor to manage a group of network apparatus each being configured to implement a type selected from a plurality of types, the management program controlling the processor to implement:
processing of managing, for each network apparatus in the group, information comprising at least one of a function identified by the selected type, an actual value of performance that is exerted when the function is enabled, or an actual value of reliability when the function is exerted;
requirement obtaining processing of obtaining at least one requirement out of a function requirement, a performance requirement, and a reliability requirement that are required of the type selected from the plurality of types; and
selection processing of selecting from the group a network apparatus that fulfills the at least one requirement obtained in the requirement obtaining processing, by referring to the information that is managed.
